(19) United States
(12) Patent Application Publication
(10) Pub. No.: US 2026/0369026 A1
(43) Pub. Date: Nov. 19, 2026

(54) METHOD AND APPARATUS FOR PROVIDING DETAILED PROSTATE STRUCTURE INFORMATION BY GENERATING CANDIDATE LABELS AND PRODUCING TOPOLOGICALLY CORRECTED LABEL DATA USING TOPOLOGICAL CONSTRAINT RULES AND A SELF CORRECTING ALGORITHM FROM PROSTATE MEDICAL IMAGES

(71) Applicant: UIF (University Industry Foundation), Yonsei University, Seoul (KR)

(72) Inventors: Jongsoo LEE, Seoul (KR); Jongjin YOON, Seoul (KR); Hyunho HAN, Seoul (KR); Young Deuk CHOI, Seoul (KR); Joo Yong LEE, Seoul (KR); Won Sik JANG, Seoul (KR); Ji Eun HEO, Seoul (KR)

(73) Assignee: UIF (University Industry Foundation), Yonsei University, Seoul (KR)

(21) Appl. No.: 19/577,896

(22) Filed: Mar. 25, 2026

(30) Foreign Application Priority Data
Apr. 2, 2025 (KR) 10-2025-0042766
Jan. 15, 2026 (KR) 10-2026-0008278

(51) Int. Cl. G06V 10/26; G06V 10/25; G06V 10/764; G06V 10/774; G06V 10/776; G06V 10/82; G06V 20/64; G06V 20/70

(52) U.S. Cl. CPC G06V 10/26; G06V 10/25; G06V 10/764; G06V 10/776; G06V 20/64; G06V 20/70; G06V 10/774; G06V 10/82; G06V 2201/031

(57) ABSTRACT

The present disclosure relates to a method and an apparatus for providing detailed structural information of a prostate by segmenting prostate substructures from prostate medical images. More particularly, the present disclosure provides a technique for improving reliability and structural consistency of prostate substructure information by applying topological constraint rules, defined based on anatomical prior knowledge of the prostate, to candidate label data generated by a trained segmentation model to detect anatomically impossible structures and by generating topologically corrected label data using a self-correcting algorithm.

### CROSS-REFERENCE TO RELATED APPLICATION

This application claims priority to and the benefit of Korean Patent Application No. 10-2025-0042766, filed on Apr. 2, 2025, and Korean Patent Application No. 10-2026-0008278, filed on Jan. 15, 2026, the disclosure of which is incorporated herein by reference in its entirety.

### BACKGROUND

### 1. Field of the Invention

The present disclosure relates to a method and an apparatus for providing detailed structural information of a prostate by segmenting prostate substructures from prostate medical images. More particularly, the present disclosure provides a technique for improving reliability and structural consistency of prostate substructure information by applying topological constraint rules, defined based on anatomical prior knowledge of the prostate, to candidate label data generated by a trained segmentation model to detect anatomically impossible structures and by generating topologically corrected label data using a self-correcting algorithm.

### 2. Discussion of Related Art

In diagnosis of prostate diseases and in establishing treatment plans, it is important to accurately identify the morphology, boundaries, and spatial relationships of detailed structures of the prostate. In particular, if structural characteristics within the prostate can be distinguished and presented based on medical images, a stronger basis for clinical decision-making may be provided.

In this regard, technologies for automatically segmenting the prostate from medical images such as Magnetic Resonance Imaging (MRI) or Computed Tomography (CT) images and providing structural information based on segmentation results have been continuously developed. Such automatic segmentation technologies have been used to reduce the time and cost required for manual labeling and to reduce variability depending on the examiner.

Recently, approaches using deep learning-based segmentation models have been widely attempted, in which the prostate and surrounding structures are classified at a voxel level and shapes and volumes of detailed structures are derived based on the classification results. However, due to variations in image quality, anatomical differences among patients, and differences in imaging conditions, errors are frequently included in candidate label data output by the models.

In particular, segmentation models tend to rely heavily on local image features, which may result in anatomically impossible label arrangements. For example, a region may protrude outside another region, or an isolated structure in which a specific label appears separately from other regions may be generated, resulting in outputs that do not correspond to actual anatomical structures.

Such errors are not limited to degradation of visual quality but may directly impair the reliability of structural information. Furthermore, when the structural information is used in subsequent processes such as volume measurement, lesion localization, or derivation of clinical indicators, the errors may propagate sequentially and degrade the performance of diagnostic assistance.

To address these issues, methods have been used in which segmentation results are smoothed through post-processing or noise is removed through morphological operations. However, such methods do not explicitly consider anatomical relationships and may distort actual boundaries or remove important structural characteristics, thereby potentially reducing accuracy.

In addition, detailed prostate structures often exhibit spatial constraints such as containment relationships, adjacency relationships, and separation relationships. However, existing approaches have limitations in explicitly reflecting such constraints as rules, or even when reflected, in consistently enforcing such constraints. As a result, even when candidate label data has a form that is difficult to accept clinically, there is often a lack of a systematic process for detecting and correcting such inconsistencies.

Accordingly, what is required in providing prostate substructure information based on medical images is a technical means that enables structural consistency validation and error correction by reflecting anatomical prior knowledge with respect to outputs of segmentation models. Therefore, there is a need for a method and an apparatus capable of reliably providing prostate substructure information by detecting anatomically impossible structures through applying topological constraints to candidate label data generated from prostate medical images and correcting the detected structures through a self-correction process.

### SUMMARY OF THE INVENTION

The present disclosure is intended to solve the above-mentioned problems and has the following objectives.

Various embodiments of The present disclosure provide a method and an apparatus for providing prostate substructure information by analyzing prostate medical images to generate candidate label data for prostate substructures, detecting anatomically impossible structures by applying topological constraint rules defined based on anatomical prior knowledge of the prostate, and performing self-correction.

Various embodiments of The present disclosure provide a method and an apparatus for automatically distinguishing prostate substructures represented as a Peripheral Zone (PZ), a non-PZ region surrounded by or adjacent to the PZ, and a Seminal Vesicle (SV), while alleviating structural errors in candidate label data generated by a segmentation model, the structural errors including containment violations and connectivity violations.

Various embodiments of The present disclosure provide a method and an apparatus for determining structural consistency using topological constraint rules expressed as a containment relationship and a connectedness constraint, rather than relying on simple post-processing or morphological correction, and for systematically identifying error regions based on violation types and locations.

Various embodiments of The present disclosure provide a method and an apparatus for improving reliability and consistency of prostate substructure information by reconstructing labels of the candidate label data through a self-correcting algorithm when anatomically impossible structures are detected, thereby generating topologically corrected label data.

Various embodiments of The present disclosure provide a method and an apparatus for suppressing propagation of segmentation errors caused by patient-specific anatomical variations, differences in imaging conditions, image noise, or distortions into subsequent analyses by enforcing correction results such that containment relationships and connectivity relationships among prostate substructures are maintained.

Various embodiments of The present disclosure provide a method and an apparatus for supporting medical professionals in receiving structurally plausible information that is clinically interpretable when visualizing prostate substructures or outputting structural information based on the topologically corrected label data.

Various embodiments of The present disclosure provide a method and an apparatus for facilitating reliability verification of automatic analysis results and analysis of error causes by maintaining interpretability of differences between candidate label data and topologically corrected label data from a structural perspective.

Various embodiments of The present disclosure provide a method and an apparatus for stably providing prostate substructure information by combining structural consistency validation based on anatomical prior knowledge with automatic correction in prostate medical image-based substructure analysis.

The technical problems to be solved by The present disclosure are not limited to those mentioned above, and other technical problems not mentioned herein will be clearly understood by those skilled in the art from the following description.

According to various embodiments of The present disclosure, there is provided a method performed by an electronic device. The electronic device comprises an input device, an output device, a processor, and a memory. The method comprises: acquiring, by the input device, two-dimensional medical image data related to a prostate of a patient from a Magnetic Resonance Imaging (MRI) device or a Computed Tomography (CT) device; generating, by the processor, three-dimensional voxel data of the prostate based on the two-dimensional medical image data; applying, by the processor, a trained segmentation model stored in the memory to the three-dimensional voxel data to generate candidate label data in which each voxel is initially classified into a prostate substructure including at least one of a Peripheral Zone (PZ), a non-PZ region surrounded by or adjacent to the PZ, and a Seminal Vesicle (SV); applying, by the processor, topological constraint rules defined based on anatomical priors of the prostate to the candidate label data to detect anatomically impossible structures including a containment violation or a connectivity violation; executing, by the processor, a self-correcting algorithm to forcibly resolve the detected anatomically impossible structures to reconstruct the candidate label data and generate topologically corrected label data; and outputting, by the output device, prostate substructure information including the topologically corrected label data.

According to various embodiments of The present disclosure, there is provided an electronic device. The electronic device comprises: an input device; an output device; a processor; and a memory storing instructions executable by the processor. The instructions cause the processor to perform operations comprise: acquiring, by the input device, two-dimensional medical image data related to a prostate of a patient from a Magnetic Resonance Imaging (MRI) device or a Computed Tomography (CT) device; generating, by the processor, three-dimensional voxel data of the prostate based on the two-dimensional medical image data; applying, by the processor, a trained segmentation model stored in the memory to the three-dimensional voxel data to generate candidate label data in which each voxel is initially classified into a prostate substructure including at least one of a Peripheral Zone (PZ), a non-PZ region surrounded by or adjacent to the PZ, and a Seminal Vesicle (SV); applying, by the processor, topological constraint rules defined based on anatomical priors of the prostate to the candidate label data to detect anatomically impossible structures including a containment violation or a connectivity violation; executing, by the processor, a self-correcting algorithm to forcibly resolve the detected anatomically impossible structures to reconstruct the candidate label data and generate topologically corrected label data; and outputting, by the output device, prostate substructure information including the topologically corrected label data.

According to various embodiments of The present disclosure, there is provided a non-transitory computer-readable storage medium having stored thereon instructions that, when executed by at least one processor, cause the at least one processor to perform operations, wherein the operations comprise the steps of the method performed by the electronic device according to various embodiments of The present disclosure.

### BRIEF DESCRIPTION OF THE DRAWINGS

FIG. 1 illustrates an overview of an operation of an electronic device according to various embodiments of The present disclosure.

FIG. 2 illustrates a configuration of an electronic device according to various embodiments of The present disclosure.

FIG. 3 illustrates a method of operation of an electronic device according to various embodiments of The present disclosure.

FIG. 3A illustrates a method of operation of an electronic device according to various embodiments of The present disclosure.

FIG. 4 illustrates a structure of a multi-layer perceptron (MLP) for implementing a deep learning algorithm according to various embodiments of The present disclosure.

FIG. 5 illustrates an example of a preprocessing process of image data before inputting the image data to an artificial intelligence model according to various embodiments of The present disclosure.

FIG. 6 illustrates an example of an artificial intelligence model for detecting prostate cancer according to various embodiments of The present disclosure.

FIG. 7 illustrates an example of a 3D U-Net structure (MRI image input example) according to various embodiments of The present disclosure.

FIG. 8 illustrates an example of an output screen of an electronic device for providing prostate substructure information based on an artificial intelligence model according to various embodiments of The present disclosure.

FIG. 9 illustrates an example of an output screen of an electronic device for providing prostate substructure information based on an artificial intelligence model according to various embodiments of The present disclosure.

### DETAILED DESCRIPTION OF EXEMPLARY EMBODIMENTS

Hereinafter, embodiments of The present disclosure will be described in detail with reference to the accompanying drawings so that those skilled in the art may easily practice The present disclosure. It should be understood that The present disclosure may be embodied in different ways and is not limited to the following embodiments.

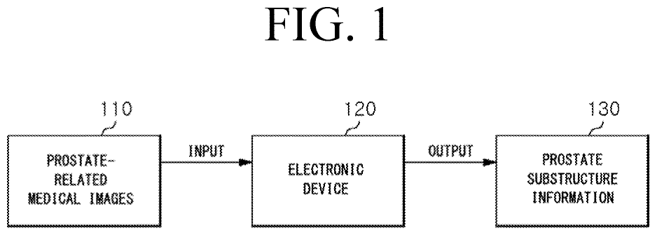

FIG. 1 illustrates an overview of an operation of an electronic device according to various embodiments of The present disclosure.

Referring to FIG. 1, an electronic device 120 according to various embodiments of The present disclosure operates in a structure in which prostate-related medical images 110 are received as input and prostate substructure information 130 is output.

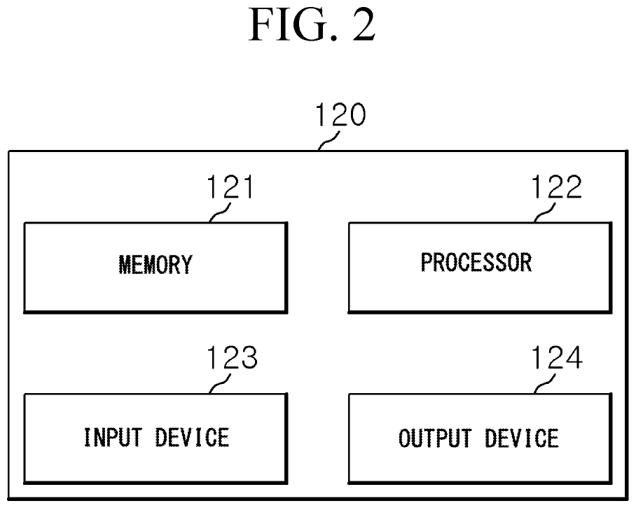

FIG. 2 illustrates a configuration of an electronic device according to various embodiments of The present disclosure.

Referring to FIG. 2, the electronic device 120 may include a memory 121, a processor 122, an input device 123, and an output device 124.

The memory 121 may be connected to the processor 122, the input device 123, and the output device 124, and may store information input through the input device 123. The memory 121 may also be connected to the processor 122 and may store data such as basic programs, application programs, configuration information for operation of the processor 122, and information generated by operations of the processor 122. The memory 121 may be configured as a volatile memory, a non-volatile memory, or a combination of volatile and non-volatile memories. The memory 121 may provide stored data according to a request from the processor 122.

The processor 122 may be configured to implement procedures and or methods proposed in The present disclosure. The processor 122 controls overall operations of the electronic device 120. For example, the processor 122 may write data to and read data from the memory 121. The processor 122 may receive information through the input device 123. The processor 122 may also output information through the output device 124. The processor 122 may include at least one processor.

The input device 123 may be connected to the processor 122 and may receive input of information. The input device 123 may include a touch display, a keypad, a keyboard, or an information input module. According to an embodiment, the electronic device 120 may further include a transceiver, and the input device 123 may receive information from another device connected through a wired or wireless communication network via the transceiver.

The output device 124 may be connected to the processor 122 and may output information in forms such as image or audio. The output device 124 may include a display, a speaker, or an information output module. According to an embodiment, the electronic device 120 may further include a transceiver, and the output device 124 may transmit and output information to another device connected through a wired or wireless communication network via the transceiver.

Although not illustrated in FIG. 2, according to an embodiment, the electronic device 120 may further include a transceiver. The transceiver may be connected to the processor 122 and may transmit and or receive signals. All or part of the transceiver may be referred to as a transmitter, a receiver, or a transceiver. The transceiver may support at least one of various wireless communication standards including IEEE 802.xx systems, IEEE Wi-Fi systems, 3GPP systems, 3GPP LTE (Long Term Evolution) systems, 3GPP 5G NR (New Radio) systems, 3GPP 6G systems, 3GPP2 systems, and Bluetooth.

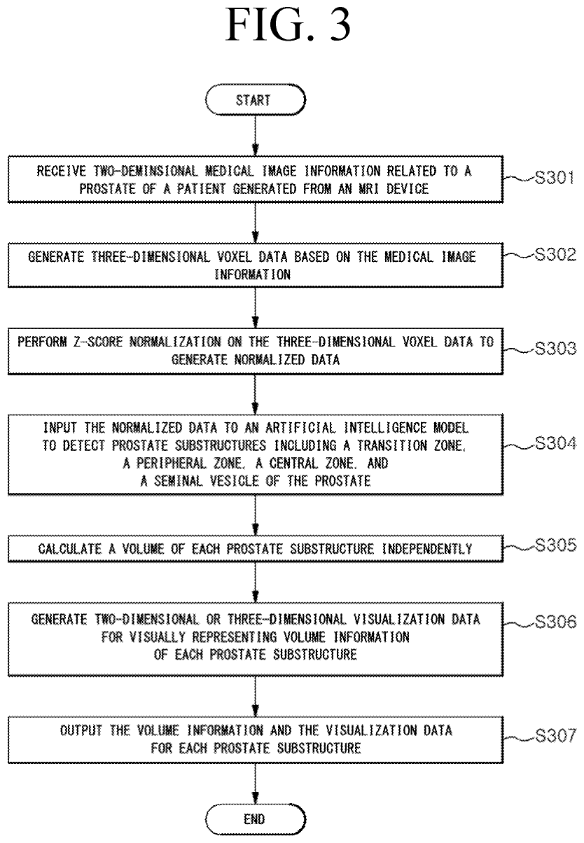

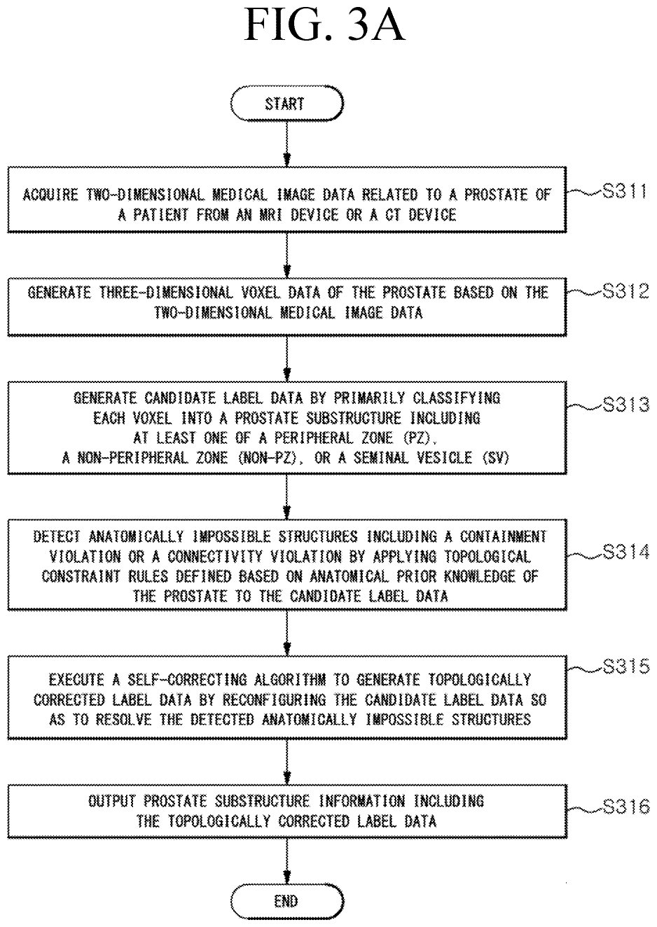

FIG. 3 illustrates a method of operation of an electronic device according to various embodiments of The present disclosure.

The embodiment of FIG. 3 illustrates an example of a method performed by an electronic device for providing detailed structure information of a prostate based on prostate images. The electronic device may include an input device, an output device, a processor, and a memory.

In step S301, the electronic device receives, via the input device, two-dimensional medical image information related to a prostate of a patient generated from a Magnetic Resonance Imaging (MRI) device.

In step S302, the electronic device generates, by the processor, three-dimensional voxel data based on the medical image information.

In step S303, the electronic device generates normalized data by performing Z-score normalization on the three-dimensional voxel data by the processor.

In step S304, the electronic device inputs the normalized data to an artificial intelligence model stored in the memory and detects, by the processor, detailed structures of the prostate including at least one of a Transition Zone (TZ), a Peripheral Zone (PZ), a Central Zone (CZ), and a Seminal Vesicle (SV).

In step S305, the electronic device independently calculates, by the processor, a volume for each of the prostate substructures.

In step S306, the electronic device generates, by the processor, two-dimensional or three-dimensional visualization data for visually representing volume information of each of the prostate substructures.

In step S307, the electronic device outputs, by the output device, the volume information of the prostate substructures and the visualization data.

According to various embodiments of The present disclosure, the three-dimensional voxel data may be generated by combining multiple two-dimensional image slices based on the medical image information.

According to various embodiments of The present disclosure, the prostate substructures may be detected by performing two-dimensional object detection for each of the multiple image slices based on the medical image information and integrating two-dimensional structural data obtained from the two-dimensional object detection performed on each of the multiple image slices into three-dimensional masking data.

According to various embodiments of The present disclosure, the artificial intelligence model may be based on a convolutional neural network (CNN). The artificial intelligence model may be trained to independently calculate volumes of the respective prostate substructures.

According to various embodiments of The present disclosure, abnormality of the prostate may be determined based on a comparison between ratios of volumes of the respective prostate substructures and volume ratios of normal prostate substructures. For example, whether benign prostatic hyperplasia of the prostate is present may be determined based on a ratio between a first volume of the Transition Zone (TZ) and a second volume of the Peripheral Zone (PZ).

According to various embodiments of The present disclosure, step S302 of generating the three-dimensional voxel data based on the medical image information by the processor may include extracting resolution information of the multiple image slices and spacing information between the multiple image slices from metadata of the medical image information, determining a region of interest (ROI) based on a central region of the prostate in the multiple image slices, and generating the three-dimensional voxel data by correcting information within the ROI of the multiple image slices based on a multi-level resampling algorithm.

According to various embodiments of The present disclosure, the Z-score normalization may be configured to remove outliers and noise of the three-dimensional voxel data by filtering based on comparison between a global average and a local average for each pixel value of the three-dimensional voxel data. The normalized data may be divided into patches within the ROI by the processor. The divided patches of the normalized data may be assigned weighted priority values according to whether the patches include the prostate substructures within the ROI and may be input to the artificial intelligence model.

According to various embodiments of The present disclosure, the normalized data may be dynamically divided into patches by the processor based on data size. In order to optimize a training speed of the artificial intelligence model, the normalized data may be divided into patches and input to the artificial intelligence model in a parallel processing manner. Among the divided patches, patches having a higher probability of including prostate substructures may be preferentially input to the artificial intelligence model for training. Different priority weights may be assigned to the divided patches so as to improve detection accuracy of the artificial intelligence model with respect to the prostate substructures.

According to various embodiments of The present disclosure, among the divided patches, patches having a higher probability of including prostate substructures may be determined by scoring inclusion probabilities of prostate substructures based on texture heterogeneity and contrast within a specific region of interest (ROI) of the prostate. Patches having scores higher than a predetermined suspicion threshold may be determined as patches having a high probability of including prostate substructures.

The region of interest (ROI) refers to a specific region in prostate images in which prostate substructures are likely to be present. The ROI may be determined based on patterns of prostate structures learned by the artificial intelligence model or may be defined by medical imaging experts.

With respect to patch division within the ROI, the prostate region may be divided into a plurality of patches and each patch may be independently evaluated to score the probability that the patch includes prostate substructures. Patch size and division methods may be determined according to analysis resolution and computational efficiency.

Texture heterogeneity represents a degree of pattern irregularity or complexity among pixels within a patch. For example, texture heterogeneity may be evaluated using a Gray-Level Co-occurrence Matrix (GLCM) to analyze distributions and correlations of gray levels of pixels. Entropy may be used to quantify randomness or irregularity of pixels within the patch. Variance may be used to identify regions having high contrast by calculating dispersion of pixel values.

Contrast represents a difference in intensity between prostate substructures and surrounding tissues and is an important factor in emphasizing characteristic patterns of prostate substructures in medical images. For example, contrast may be quantified by measuring a difference between a maximum value and a minimum value within a patch (global contrast), and boundaries between prostate substructures and surrounding tissues may be further distinguished through evaluation of local contrast.

In scoring and patch selection, each patch may be assigned a score based on texture heterogeneity and contrast. For example, a final score may be calculated using a weighted average of a texture heterogeneity score and a contrast score. Relative weights may be adjusted according to importance of texture heterogeneity and contrast. Patches having higher scores may be determined to have a higher probability of including prostate substructures. Among the scored patches, patches having highest scores or scores exceeding a threshold may be selected. The selected patches may be preferentially input to the artificial intelligence model to improve detection accuracy of prostate substructures.

The method proposed in The present disclosure provides several advantages. First, computational efficiency may be improved because only patches having a high probability of including prostate substructures are selected and input to the artificial intelligence model rather than analyzing an entire image. Second, detection accuracy may be improved because scoring based on texture heterogeneity and contrast enables clearer identification of characteristic patterns of lesions. Third, the detected patches may assist medical professionals in quickly identifying prostate substructures and efficiently support diagnostic procedures related to prostate diseases.

The method for determining patches having a high probability of including prostate substructures according to embodiments of The present disclosure evaluates and scores patches based on texture heterogeneity and contrast. Accordingly, learning and prediction accuracy of the artificial intelligence model may be maximized, and efficiency and reliability of diagnosis of prostate-related diseases may be significantly improved. As a result, medical professionals may make diagnoses based on more quantitative information, and automated analysis methods may assist decision making in clinical environments.

According to various embodiments of The present disclosure, the embodiment of FIG. 3 may further include receiving past information related to the prostate of the patient through the input device.

According to various embodiments of The present disclosure, result information may be configured to visually provide change trends based on comparison with the past information in relation to the prostate substructures.

According to various embodiments of The present disclosure, the result information may include volume information of each prostate substructure, a change rate relative to a normal range of the prostate substructures, and information indicating whether benign prostatic hyperplasia of the prostate is present based on a ratio between a first volume of the Transition Zone (TZ) and a second volume of the Peripheral Zone (PZ).

According to various embodiments of The present disclosure, an electronic device for providing prostate substructure information may include an input device, an output device, a transceiver, a processor, and a memory, wherein the memory stores instructions for operations executed by the processor, and the operations may be configured to perform the method of operation of the electronic device according to the embodiment of FIG. 3.

According to various embodiments of The present disclosure, a non-transitory computer-readable storage media storing instructions that, when executed by at least one processor, cause the at least one processor to perform operations may be provided, wherein the operations include the method of operation of the electronic device according to the embodiment of FIG. 3.

FIG. 3A illustrates a method of operation of an electronic device according to various embodiments of The present disclosure.

The embodiment of FIG. 3A illustrates an example of a method performed by an electronic device for providing prostate substructure information from prostate images. The electronic device may include an input device, an output device, a processor, and a memory.

Referring to FIG. 3A, in step S311, the electronic device acquires, by the input device, two-dimensional medical image data related to a prostate of a patient from a Magnetic Resonance Imaging (MRI) device or a Computed Tomography (CT) device.

In step S312, the electronic device generates, by the processor, three-dimensional voxel data of the prostate based on the two-dimensional medical image data.

In step S313, the electronic device applies, by the processor, a trained segmentation model stored in the memory to the three-dimensional voxel data to generate candidate label data in which each voxel is initially classified into a prostate substructure including at least one of a Peripheral Zone (PZ), a non-PZ region surrounded by or adjacent to the PZ, and a Seminal Vesicle (SV).

In step S314, the electronic device applies, by the processor, topological constraint rules defined based on anatomical priors of the prostate to the candidate label data to detect anatomically impossible structures including a containment violation or a connectivity violation.

In step S315, the electronic device executes, by the processor, a self-correcting algorithm to forcibly resolve the detected anatomically impossible structures and thereby generate topologically corrected label data by reconstructing the candidate label data.

In step S316, the electronic device outputs, by the output device, prostate substructure information including the topologically corrected label data.

This aspect includes generating three-dimensional voxel data from two-dimensional medical image data based on Magnetic Resonance Imaging (MRI) or Computed Tomography (CT), and generating candidate label data by using a trained segmentation model. In this aspect, the Peripheral Zone (PZ), the non-PZ region, and the Seminal Vesicle (SV) denote prostate substructure labels, and anatomical priors are formalized as topological constraint rules to detect a containment violation or a connectivity violation, after which topologically corrected label data is generated through a self-correcting algorithm.

This aspect has an effect of improving anatomical consistency of a result by detecting, in a rule-based manner, and forcibly resolving a case in which a label generated by the segmentation model has an anatomically impossible form. This aspect also has an effect of providing a consistent structural reference in subsequent diagnostic determination or quantitative analysis by outputting prostate substructure information including corrected labels.

According to various embodiments of The present disclosure, the non-PZ region may be configured to exist at a position included within a three-dimensional region represented by voxels corresponding to a Peripheral Zone (PZ) of the prostate or at a position spatially adjacent to a boundary of the three-dimensional region. The spatially adjacent position may be configured as a position forming a contact relationship with at least one voxel or voxel group corresponding to the PZ in a three-dimensional space. The topological constraint rules may be configured to include, based on anatomical priors of the prostate, a containment relationship requiring the non-PZ region to exist within the PZ or in a boundary-adjacent region thereof, and a connectedness constraint requiring voxels assigned to at least one of the PZ, the non-PZ region, or a Seminal Vesicle (SV) to form a single connected component.

The containment violation may be configured to include a case in which at least one connected component assigned to the non-PZ region in the candidate label data exists outside the interior or the boundary-adjacent region of the PZ. The containment violation may be configured to include a case in which voxels assigned to the non-PZ region are exposed outside without being surrounded by the PZ or exist at a spatially separated location from the PZ. The connectivity violation may be configured to include a case in which voxels assigned to an identical label in the candidate label data exist as a plurality of separated connected components or a case in which at least some of the voxels assigned to the identical label exist in the form of an isolated island. The isolated island may comprise a connected component spatially separated from a main body of the identical label and not forming a continuous adjacency path with the main body. The self-correcting algorithm may be configured to generate topologically corrected label data satisfying the topological constraint rules by reassigning a label of a connected component corresponding to the containment violation in the candidate label data, or by reassigning or removing a label of a connected component corresponding to the isolated island, so as to resolve anatomically impossible structures defined by the containment violation or the connectivity violation.

This aspect defines the non-PZ region as being located within a three-dimensional region represented by voxels of the Peripheral Zone (PZ) or at a boundary-adjacent position thereof, and defines the adjacent position as a position forming a contact relationship with a PZ voxel or voxel group. In this aspect, a single connected component means a state in which voxels assigned to an identical label are connected as one connected mass, and an isolated island and a main body mean a separated connected component and a central mass thereof, respectively, so that meanings of the topological constraint rules, the containment relationship, the connectedness constraint, the containment violation, the connectivity violation, and the self-correcting algorithm are specifically fixed.

This aspect has an effect of providing, without ambiguity, determination criteria for anatomically impossible structures by explicitly defining an allowable location range of the non-PZ region and an allowable range of connectivity. This aspect also has an effect of improving reproducibility and explainability of a correction result by defining generation of corrected label data through reassignment or removal of a label of a connected component according to a type of violation.

According to various embodiments of The present disclosure, the topological constraint rules may be configured to include a containment relationship configured such that a three-dimensional spatial position of voxels assigned to the non-PZ region is restricted to an interior of voxels assigned to the Peripheral Zone (PZ) or to a boundary-adjacent region thereof. The containment violation may be configured to include a case in which at least one connected component assigned to the non-PZ region in the candidate label data exists outside the interior or the boundary-adjacent region of the PZ. The containment violation may be configured to include a case in which voxels assigned to the non-PZ region are exposed outside without being surrounded by the PZ or exist at a spatially separated location from the PZ.

This aspect defines the containment relationship as a relationship in which a three-dimensional spatial position of a voxel assigned to the non-PZ region is restricted to an interior of voxels assigned to the Peripheral Zone (PZ) or to a boundary-adjacent region thereof. In this aspect, the containment violation means a state in which a connected component of the non-PZ region exists outside the interior or the boundary-adjacent region of the PZ in the candidate label data, and is specifically fixed to include a case of exterior exposure or spatial separation.

This aspect has an effect of improving clarity of violation detection by directly encompassing representative error forms such as protrusion or separation of the non-PZ region within a determination rule. This aspect also has an effect of rapidly specifying a point at which automatic correction is needed because whether the rule is satisfied directly functions as a quality metric of a segmentation result.

According to various embodiments of The present disclosure, the topological constraint rules may be configured such that voxels assigned to at least one of the Peripheral Zone (PZ), the non-PZ region, and the Seminal Vesicle (SV) in the candidate label data satisfy a connectedness constraint, respectively. The connectivity violation may be configured to include a case in which voxels assigned to an identical label exist as a plurality of separated connected components, or a case in which at least some of the voxels assigned to the identical label exist in the form of an isolated island. The isolated island may comprise a connected component that is spatially separated from a main body of the identical label and does not form a continuous adjacency path with the main body.

This aspect defines the connectedness constraint such that voxels assigned to at least one of the Peripheral Zone (PZ), the non-PZ region, and the Seminal Vesicle (SV) satisfy a connectivity condition, respectively. In this aspect, the connectivity violation means a state in which voxels assigned to an identical label are separated into a plurality of connected components or exist in the form of an isolated island, and the relationship between the isolated island and the main body is defined by spatial separation and absence of a continuous adjacency path.

This aspect has an effect of reducing clinically meaningful structural distortion by capturing collapse of continuity of a structure, rather than a simple area-based error, as a quality issue. This aspect also has an effect of stably defining a scope in which a correcting algorithm should intervene because the definition of the connectivity violation is clear.

According to various embodiments of The present disclosure, the connectedness constraint may further include conditional validation logic configured to determine whether the connectivity violation corresponds to an anatomically valid separation by referencing an anatomical exception database stored in the memory, without immediately determining the connectivity violation as an error even when the connectivity violation exists. The anatomical exception database may include exception rules defining types of cases in which a plurality of connected components assigned to a specific label are anatomically allowable, the exception rules being defined in association with positional characteristics or morphological characteristics of the connected components based on patient-specific characteristic data including image acquisition conditions, image distortion information, presence of Benign Prostatic Hyperplasia (BPH), surgical history, and lesion-related clinical information. The conditional validation logic may be configured to determine whether the exception rules are satisfied by matching a spatial location of the connectivity violation, morphological characteristics of the connected components, and the patient-specific characteristic data, and to allow the plurality of connected components for the specific label only when the exception rules are satisfied.

This aspect includes conditional validation logic that references an anatomical exception database rather than immediately determining a violation of the connectedness constraint as an error. In this aspect, an anatomically valid separation means a form of separation that may be allowed based on patient-specific characteristic data including image acquisition conditions, image distortion information, presence of Benign Prostatic Hyperplasia (BPH), surgical history, and lesion-related clinical information, and exception rules are defined in association with positional characteristics or morphological characteristics.

This aspect has an effect of reducing excessive false detections by systematically reflecting actual patient situations deviating from a normal form due to lesions or surgery. This aspect also has an effect of reducing a risk of unnecessarily merging a clinically valid structure during a correction process because conditions for allowing an exception are explicitly defined.

According to various embodiments of The present disclosure, the self-correcting algorithm may be configured to perform label reconstruction using a representation in which the candidate label data is converted from individual voxel units into voxel groups in a form of super-voxels aggregated based on label similarity and spatial adjacency. The voxel groups may be defined as atomic processing units configured such that segmentation is maintained near boundaries of prostate substructures while merging is performed in internal regions so as to preserve boundary surfaces of the prostate substructures. The label reconstruction may be performed on the basis of the voxel group units so as to reduce computational complexity compared with voxel-level reconstruction while suppressing distortion of anatomical boundaries.

This aspect performs label reconstruction by converting the candidate label data into a representation in units of voxel groups in the form of super-voxels. In this aspect, a super-voxel means a set of voxels aggregated according to spatial adjacency and label similarity, and an atomic processing unit means a minimum processing unit in which segmentation is maintained near boundaries and merging is performed in internal regions for preserving a boundary surface.

This aspect has an effect of reducing computation compared with voxel-level optimization while suppressing excessive fluctuation of anatomical boundaries. This aspect also has an effect of improving consistency and convergence of a correction result by structurally stabilizing a basic unit on which correction is performed.

According to various embodiments of The present disclosure, the self-correcting algorithm may be configured to perform the label reconstruction using a topological graph model in which the voxel groups are treated as nodes and edges are assigned between voxel groups that are adjacent to or in contact with each other in a three-dimensional space. Each of the edges may include label compatibility information indicating whether a label combination of two adjacent voxel groups is anatomically coexistent, and the label compatibility information may be configured to assign different constraint strengths to at least one label pair among (1) Peripheral Zone (PZ) and non-PZ, (2) Peripheral Zone (PZ) and Seminal Vesicle (SV), and (3) non-PZ and Seminal Vesicle (SV).

This aspect performs label reconstruction by using a topological graph model in which voxel groups are treated as nodes and edges are assigned between adjacent or contacting voxel groups. In this aspect, nodes and edges mean voxel groups and adjacency relationships thereof, respectively, and the label compatibility information is information reflecting a degree of constraint as to whether a label combination of two nodes is anatomically coexistent, such that different strengths are assigned for respective label pairs.

This aspect has an effect of preventing a correction determination from being affected by local pixel noise by fixing a spatial adjacency relationship as a graph structure. This aspect also has an effect of directly reflecting differences in actual anatomical contact possibility in a correction process by varying constraint strengths for respective label pairs.

According to various embodiments of The present disclosure, the self-correcting algorithm may be configured to perform the label reconstruction using an energy minimization technique based on Graph Cut or Markov Random Field (MRF). The energy minimization may be configured to minimize an objective function including (i) a unary cost reflecting label confidence produced by the trained segmentation model, and (ii) a pairwise cost assigning different penalties to adjacent label pairs that violate the topological constraint rules according to violation types. The objective function may be configured such that a label reconstruction that leaves a containment violation or a connectivity violation remaining is not selected by assigning a penalty structure corresponding to the violation types.

This aspect performs label reconstruction using energy minimization based on Graph Cut or Markov Random Field (MRF). In this aspect, the unary cost is a cost reflecting label confidence produced by the trained segmentation model, the pairwise cost is a cost assigning violation type-specific penalties to label pairs violating the topological constraint rules, and the objective function is a function to be minimized including the unary cost and the pairwise cost.

This aspect has an effect of reducing both excessive correction and insufficient correction by simultaneously satisfying data reliability and anatomical consistency within a single optimization framework. This aspect also has an effect of ensuring structural integrity by guiding selection away from a solution in which a containment violation or a connectivity violation remains through a penalty structure corresponding to violation types.

According to various embodiments of The present disclosure, the topologically corrected label data may simultaneously satisfy conditions in which (a) each connected component assigned to the non-PZ region is corrected to exist within an interior of the Peripheral Zone (PZ) or within a boundary-adjacent region thereof, (b) voxels assigned to the non-PZ region are corrected such that no isolated island remains within the PZ, and (c) voxels assigned to the Seminal Vesicle (SV) are corrected such that they do not overlap with voxels assigned to the PZ or the non-PZ region.

This aspect specifically defines corrected states that the topologically corrected label data is to satisfy simultaneously. In this aspect, the corrected states are fixed to include positional consistency of a connected component of the non-PZ region, removal of an isolated island of the non-PZ region, and removal of overlap between the Seminal Vesicle (SV) and another label.

This aspect has an effect of facilitating subsequent evaluation and verification by clearly defining a quality criterion of a correction result as an attribute of an output itself. This aspect also has an effect of reducing residual errors caused by partially optimal correction satisfying only a single constraint by satisfying a plurality of constraints simultaneously.

According to various embodiments of The present disclosure, the candidate label data may include, for each voxel, at least one label among the Peripheral Zone (PZ), the non-PZ region, and the Seminal Vesicle (SV). The candidate label data may further include, for each voxel, label confidence information corresponding to the label. The label confidence information may be expressed as a label-specific probability map derived from an output of a Softmax layer of the trained segmentation model or an entropy-based uncertainty value, and may be used as an input variable of the self-correcting algorithm.

This aspect specifies that the candidate label data includes label confidence information. In this aspect, the output of the Softmax layer means a label-specific probability output of the segmentation model, a probability map means a spatial distribution of label-specific probability values, and entropy-based uncertainty means a value quantifying a degree of prediction uncertainty.

This aspect has an effect of reducing unnecessary label flipping by enabling the correcting algorithm to quantitatively compare a risk and a benefit of label change. This aspect also has an effect of improving efficiency of correction resources by guiding correction to be concentrated on a region having high uncertainty.

According to various embodiments of The present disclosure, the candidate label data may be generated not as a single determined label but in the form of a probabilistic label distribution corresponding to each of the Peripheral Zone (PZ), the non-PZ region, and the Seminal Vesicle (SV) for each voxel. The self-correcting algorithm may be configured to consider a label candidate having a second highest probability in the probabilistic label distribution and to switch to a most anatomically valid alternative label when a topological violation occurs.

This aspect specifies that the candidate label data is generated as a probabilistic label distribution rather than as a determined label. In this aspect, a probabilistic label distribution means an expression containing relative possibilities for a plurality of label candidates, and a second highest probability label candidate means a candidate label having a high possibility of substitution when a highest-ranked label is excluded due to a constraint violation.

This aspect has an effect of improving stability of correction because a basis for selecting an alternative label is provided by a probability distribution when a constraint violation occurs. This aspect also has an effect of reducing information loss because multiple candidate information of the model is utilized while performing an anatomically valid transition.

According to various embodiments of The present disclosure, the anatomical priors may include an adjacency matrix defining spatial relationships among prostate substructures in the form of a matrix. The adjacency matrix may be configured to assign a cost lower than a threshold cost to label pairs for which contact is permitted, including (1) Peripheral Zone (PZ) and non-PZ, or (2) Peripheral Zone (PZ) and Seminal Vesicle (SV). The adjacency matrix may be configured to assign a cost higher than the threshold cost to a label pair for which contact is anatomically rare, including (3) non-PZ and Seminal Vesicle (SV). The adjacency matrix may be used as reference data of the topological constraint rules.

This aspect specifies that the anatomical priors are expressed as an adjacency matrix. In this aspect, the adjacency matrix is a structure containing, as costs of matrix elements, tendencies of label pairs as to whether contact is permitted or prohibited, and the threshold cost means a reference cost distinguishing contact permission from a strong constraint.

This aspect has an effect of enabling consistent application of constraints in graph-based correction by providing contact possibility for each label pair as quantified reference data. This aspect also has an effect of reducing a tendency for anatomically abnormal coupling to be selected by assigning a high cost to a label pair for which contact is rare.

According to various embodiments of The present disclosure, the anatomically impossible structures may be expressed such that regions corresponding to the containment violation or the connectivity violation are represented together with a set of positions of voxels and a violation type identifier. The violation type identifier may include information indicating whether the violation corresponds to the containment violation or the connectivity violation, and label identification information indicating which of the Peripheral Zone (PZ), the non-PZ region, and the Seminal Vesicle (SV) corresponds to the violation.

This aspect specifies that the anatomically impossible structures are expressed together with the violation type identifier. In this aspect, the violation type identifier is identification information indicating both whether the violation is the containment violation or the connectivity violation and which of the Peripheral Zone (PZ), the non-PZ region, and the Seminal Vesicle (SV) is associated with the violation.

This aspect has an effect of allowing a prescription of the correcting algorithm to be selected in a rule-based manner because both a type of violation and a target label are specified simultaneously. This aspect also has an effect of facilitating cause tracking in quality management and error analysis because records of violations may be stored in a structured manner.

According to various embodiments of The present disclosure, the topologically corrected label data may further include, for each voxel or voxel group, a change flag bitmap indicating whether a label has been changed relative to the candidate label data. The change flag may indicate, as a binary value or a multi-valued value, whether the label has been maintained or changed.

This aspect specifies that the topologically corrected label data includes a change flag bitmap. In this aspect, the change flag is a value indicating whether a label has been maintained or changed relative to the candidate label data, and the bitmap means an expression in which flags for spatial positions are stored in the form of an array.

This aspect has an effect of providing a basis for explaining reliability of a result by allowing a region in which correction has actually intervened to be directly identified. This aspect also has an effect of efficiently narrowing a section requiring subsequent review or clinical confirmation based on the changed region.

According to various embodiments of The present disclosure, the topologically corrected label data may further include, for a voxel or voxel group whose label has been changed, rule type metadata indicating a type of topological constraint rule that caused the change. The rule type metadata may be expressed so as to distinguish whether the change resulted from resolution of the containment violation or from resolution of the connectivity violation.

This aspect specifies that the topologically corrected label data includes rule type metadata. In this aspect, the rule type metadata is metadata that records, in a distinguishable manner, whether the change resulted from resolution of the containment violation or from resolution of the connectivity violation.

This aspect has an effect of improving interpretability of a result and post-verification capability because a reason for label change is recorded at a type level. This aspect also has an effect of deriving improvement directions for the topological constraint rules and model training because a frequency and a location can be analyzed for each type of violation.

According to various embodiments of The present disclosure, the prostate substructure information may further include a topological consistency indicator indicating, in a comparable manner, a topological consistency state of the candidate label data and a topological consistency state of the topologically corrected label data. The topological consistency indicator may be expressed as information indicating at least one of whether a containment violation and a connectivity violation are satisfied, whether each type of violation has occurred, and whether each type of violation remains.

This aspect specifies that the prostate substructure information includes a topological consistency indicator. In this aspect, the topological consistency indicator means indicator information indicating at least one of whether the containment violation and the connectivity violation are satisfied, whether they have occurred, and whether they remain.

This aspect has an effect of enabling immediate quality comparison by presenting structural consistency before and after correction as a quantitative or qualitative indicator. This aspect also has an effect of improving interpretability in performance evaluation and clinical verification because the indicator can be decomposed for each type of violation.

According to various embodiments of The present disclosure, the topological constraint rules may further include a separation constraint defined such that a continuous contact path is not formed between voxels assigned to the Seminal Vesicle (SV) and voxels assigned to the Peripheral Zone (PZ) or the non-PZ region. The separation constraint may be defined to prohibit, when voxels of the Seminal Vesicle (SV) label are in contact with voxels of the Peripheral Zone (PZ) label or the non-PZ region label, such contact from continuously extending so that the Seminal Vesicle (SV) is combined with the Peripheral Zone (PZ) or the non-PZ region at a connected-component level.

This aspect specifies that the topological constraint rules include a separation constraint of the Seminal Vesicle (SV). In this aspect, the separation constraint means a constraint prohibiting contact of voxels of the Seminal Vesicle (SV) label with the Peripheral Zone (PZ) or the non-PZ region from continuously extending into a coupled state at a connected-component level, even when such contact occurs.

This aspect has an effect of preventing an error in which the Seminal Vesicle (SV) is abnormally connected to another structure, thereby securing independence of anatomical boundaries. This aspect also has an effect of providing a practical separation criterion without excessive exclusion by distinguishing between one-time contact being allowable and coupling at a connected-component level being prohibited.

According to various embodiments of The present disclosure, the prostate substructure information may further include overlay information indicating, in a visually distinguishable manner, differences before and after correction by overlaying the candidate label data and the topologically corrected label data on the two-dimensional medical image data or the three-dimensional voxel data. The overlay information may be configured to display label boundaries of the candidate label data and label boundaries of the topologically corrected label data in a mutually distinguishable manner or to highlight a region in which label change has occurred.

This aspect specifies that the prostate substructure information includes overlay information. In this aspect, the overlay information is visual information for overlaying the candidate label data and the topologically corrected label data on the two-dimensional medical image data or the three-dimensional voxel data, and is configured to allow label boundary distinction or highlighting of a changed region.

This aspect has an effect of reducing review time and increasing trust of medical professionals by allowing differences before and after correction to be checked intuitively. This aspect also has an effect of enabling validity of correction to be quickly checked on a case-by-case basis because a changed region is visually distinguished.

According to various embodiments of the present disclosure, the candidate label data may further include label confidence information corresponding to the Peripheral Zone (PZ), the non-PZ region, and the Seminal Vesicle (SV) for each voxel or voxel group. The label confidence information may include a probability distribution derived from an output of a Softmax layer of the trained segmentation model or an entropy-based uncertainty value. The self-correcting algorithm may determine whether to reassign a label of a voxel or voxel group when a containment violation or a connectivity violation is detected by jointly evaluating a violation residual cost corresponding to maintaining a currently assigned label, a violation resolution gain corresponding to switching the currently assigned label to a label candidate having a second highest probability in the probability distribution, and a label transition stability score derived from the entropy-based uncertainty value. The self-correcting algorithm may reassign the label of the voxel or voxel group to an anatomically valid alternative label only when the violation residual cost exceeds a predetermined threshold and the label transition stability score exceeds a predetermined stability threshold.

This aspect configures the candidate label data to include label confidence information expressed as a probability distribution or uncertainty value. In this configuration, the probability distribution means relative likelihood values corresponding to each of the Peripheral Zone (PZ), the non-PZ region, and the Seminal Vesicle (SV), and the entropy-based uncertainty value means a value quantifying prediction uncertainty of the trained segmentation model. The violation residual cost means a cost corresponding to maintaining a label assignment that leaves the containment violation or the connectivity violation unresolved, the violation resolution gain means an improvement corresponding to switching the label to a candidate label having a second highest probability, and the label transition stability score means an index indicating reliability of label reassignment based on uncertainty information.

This aspect has an effect in that correction of anatomically impossible structures is performed based on both anatomical constraints and probabilistic reliability of the trained segmentation model. This aspect has an effect in that unnecessary label reassignment is reduced by allowing label switching only when a violation residual cost and a label transition stability score satisfy predetermined conditions. This aspect has an effect in that an anatomically valid alternative label can be selected using probabilistic information of the trained segmentation model, thereby improving both stability and accuracy of the topological correction.

According to various embodiments of the present disclosure, the anatomical priors may include an adjacency matrix defining spatial relationship constraints among the Peripheral Zone (PZ), the non-PZ region, and the Seminal Vesicle (SV). The adjacency matrix may assign a first cost to a label pair corresponding to the Peripheral Zone (PZ) and the non-PZ region, a second cost to a label pair corresponding to the Peripheral Zone (PZ) and the Seminal Vesicle (SV), and a third cost greater than the first cost and the second cost to a label pair corresponding to the non-PZ region and the Seminal Vesicle (SV). The self-correcting algorithm may reconstruct the candidate label data by minimizing an objective function including a contact cost derived from the adjacency matrix, a first penalty corresponding to the containment violation, a second penalty corresponding to the connectivity violation, and a third penalty corresponding to a separation constraint violation in which voxels assigned to the Seminal Vesicle (SV) form a continuous connected component with voxels assigned to the Peripheral Zone (PZ) or the non-PZ region.

This aspect configures the anatomical priors as an adjacency matrix representing spatial contact relationships among prostate substructures. In this configuration, the adjacency matrix means a matrix structure in which a spatial adjacency relationship between two labels is represented as a cost value, and the cost value indicates a degree of anatomical permissibility of spatial contact. The containment violation means a state in which voxels assigned to the non-PZ region exist outside an interior or boundary-adjacent region of the Peripheral Zone (PZ), and the connectivity violation means a state in which voxels assigned to an identical label exist as separated connected components or isolated islands. The separation constraint means a constraint that prevents voxels assigned to the Seminal Vesicle (SV) from forming a continuous connected component with voxels assigned to the Peripheral Zone (PZ) or the non-PZ region.

This aspect has an effect in that spatial relationships among prostate substructures are quantified as cost values and incorporated into the correction process. This aspect has an effect in that anatomical plausibility is directly reflected in an optimization process because label reconstruction is guided by the adjacency matrix and penalty structures corresponding to violation types. This aspect has an effect in that abnormal coupling between the Seminal Vesicle (SV) and other prostate substructures is prevented by applying the separation constraint, thereby improving anatomical consistency of the corrected label data.

According to various embodiments of the present disclosure, the prostate substructure information may further include a change flag bitmap indicating whether a label has been changed relative to the candidate label data for each voxel or voxel group, rule type metadata indicating a type of the topological constraint rule that caused the label change, and a topological consistency indicator representing a topological consistency state of the candidate label data and a topological consistency state of the topologically corrected label data in a comparable manner. The rule type metadata may indicate whether the label change results from resolution of the containment violation or resolution of the connectivity violation. The topological consistency indicator may include at least one of whether the containment violation exists, whether the connectivity violation exists, a number of violations detected before execution of the self-correcting algorithm, a number of violations remaining after generation of the topologically corrected label data, or a violation resolution ratio.

This aspect configures the prostate substructure information to include structured metadata describing correction history and topological consistency. In this configuration, the change flag bitmap means bitmap data indicating, for each spatial position corresponding to a voxel or voxel group, whether a label has been maintained or changed relative to the candidate label data. The rule type metadata means metadata indicating which type of topological constraint rule caused a label change, and the topological consistency indicator means indicator information representing a structural consistency state of segmentation results before and after correction.

This aspect has an effect in that interpretability of a correction process is improved because information indicating which labels have been changed and which rules caused the change is provided together with the corrected result. This aspect has an effect in that reliability evaluation of the topologically corrected label data is facilitated because topological consistency before and after correction can be directly compared using the topological consistency indicator. This aspect has an effect in that subsequent clinical verification or quality control can be efficiently performed because a spatial distribution of label changes is explicitly recorded.

According to various embodiments of The present disclosure, there is provided an electronic device comprising an input device, an output device, a transceiver, a processor, and a memory, wherein the memory stores instructions for operations performed by the processor, and the operations are configured to perform the method of operation of the electronic device according to the embodiment of FIG. 3A.

According to various embodiments of The present disclosure, there is provided a non-transitory computer-readable storage medium having stored thereon instructions that, when executed by at least one processor, cause the at least one processor to perform operations, wherein the operations are configured to include the method of operation of the electronic device according to the embodiment of FIG. 3A.

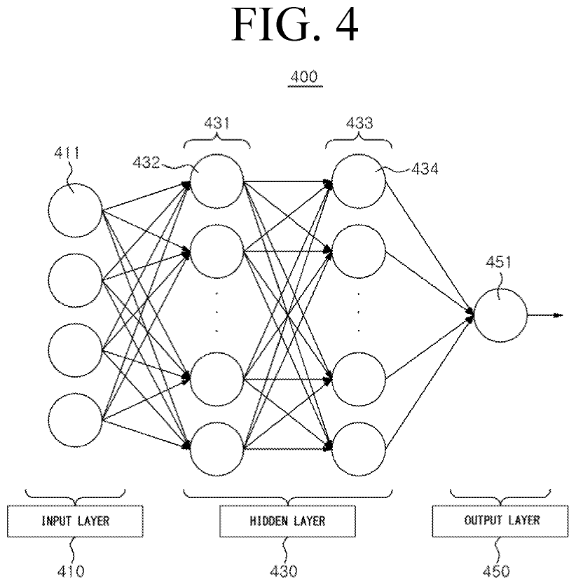

FIG. 4 illustrates a structure of a multi-layer perceptron (MLP) for implementing a deep learning algorithm according to various embodiments of The present disclosure.

According to various embodiments of The present disclosure, a prostate substructure detection model according to The present disclosure may be configured in the structure of a Multi-Layer Perceptron (MLP) as illustrated in the embodiment of FIG. 4. The prostate substructure detection model may be implemented using various architectures including a Convolutional Neural Network (CNN), DenseNet, U-Net, GoogLeNet, and a Generative Adversarial Network (GAN). For example, when the prostate substructure detection model is implemented as a CNN, the model performs a training process that adjusts connection weights of an artificial neural network using training data.

Deep learning is one of the technologies that has recently emerged in the field of machine learning. A deep learning model generally includes a neural network composed of multiple hidden layers and a plurality of hidden units included in each layer. When low-level features are input to a deep learning model, the low-level features pass through multiple hidden layers and are transformed into higher-level features that more effectively describe the prediction problem. Because this process does not require expert prior knowledge or intuition, subjective factors in feature extraction may be reduced, thereby enabling development of models having improved generalization capability. Furthermore, in deep learning, feature extraction and model construction are integrated into a single framework, which allows the final model to be constructed through a simpler process compared with conventional machine learning approaches.

A multi-layer perceptron (MLP) is a type of artificial neural network (ANN) based on deep learning and includes multiple nodes arranged in layers. Each node functions similarly to a biological neuron and employs a nonlinear activation function. Due to this nonlinear characteristic, the MLP can linearly separate data that are otherwise not linearly separable.

Referring to FIG. 4, an artificial neural network 400 of the MLP model according to various embodiments of The present disclosure includes an input layer 410, a plurality of hidden layers 430, and an output layer 450.

Nodes of the input layer 410 receive input data including a plurality of parameters related to a medical image. The plurality of parameters related to the medical image 411 correspond to low-level features of the deep learning model.

Nodes of the hidden layers 430 perform computations based on the input parameters. The hidden layers 430 may include units defined as sets of nodes formed by combining the plurality of parameters 411 related to the medical image. As illustrated in FIG. 4, the hidden layers 430 may include multiple hidden layers.

For example, when the hidden layers 430 include a first hidden layer 431 and a second hidden layer 433, the first hidden layer 431 stores first units 432 defined as nodes generated by combining the plurality of parameters 411 related to the medical image, which correspond to higher-level features derived from the input parameters. The second hidden layer 433 stores second units 434 defined as nodes generated by combining the first units 432 of the first hidden layer 431. The second units 434 correspond to higher-level features of the first units 432.

Nodes of the output layer 450 represent predicted results. The output layer 450 may include a plurality of prediction result units 451. Specifically, the prediction result units 451 may include two units: a True unit and a False unit. The True unit represents a prediction result indicating that the medical image is related to a particular feature, while the False unit represents a prediction result indicating that the medical image is not related to the particular feature.

Each connection between the second units 434 included in the second hidden layer 433, which is the last hidden layer, and the prediction result units 451 is assigned a corresponding weight. Based on these weights, the relationship between the medical image and a particular feature may be predicted.

For example, when one of the second units 434 predicts that the medical image is related to a particular feature, the unit is connected to both the True unit and the False unit. A positive weight may be assigned to the connection with the True unit, while a negative weight may be assigned to the connection with the False unit. Conversely, when one of the second units 434 predicts that the medical image is not related to the particular feature, a negative weight may be assigned to the connection with the True unit and a positive weight may be assigned to the connection with the False unit.

A plurality of connection lines may be formed between the plurality of second units 434 and the True unit. When the sum of the weights of the plurality of connection lines has a positive value, the plurality of parameters 411 related to the medical image in the input layer 410 may be predicted as parameters indicating that the medical image is related to the particular feature. In some embodiments, whether the medical image is related to the particular feature may be predicted by comparing the sum of the connection weights with a predetermined threshold value.

The artificial neural network 400 of the MLP model is trained by adjusting training parameters. In some embodiments, the training parameters may include at least one of weights and biases. The training parameters are repeatedly adjusted through an optimization algorithm referred to as gradient descent. Each time a prediction result is calculated from a given data sample through forward propagation, the performance of the network is evaluated using a loss function that measures prediction error. Each training parameter of the artificial neural network 400 is adjusted incrementally in a direction that minimizes the value of the loss function, and this process is referred to as back-propagation.

The present disclosure provides a software program that analyzes MRI images to detect prostate substructures and accurately measure volumes of the respective substructures, thereby assisting users in performing diagnosis of prostate diseases more efficiently.

The present disclosure supports DICOM and NIFTI standards that are widely used in medical devices and PACS (Picture Archiving and Communication System) software. Medical images captured as multiple slices may be visualized in both two-dimensional and three-dimensional forms so that region information and volume information for each prostate substructure may be intuitively provided to a user.

Furthermore, the volumes of individual prostate substructures including a Transition Zone (TZ), Peripheral Zone (PZ), Central Zone (CZ), and Seminal Vesicle (SV) may be independently measured and compared with normal ranges to evaluate the presence of benign prostatic hyperplasia and to monitor changes in the prostate substructures over time.

By automating the processes of prostate substructure volume measurement and visualization, The present disclosure enables users to perform prostate disease diagnosis procedures more conveniently and accurately.

The software is configured with an artificial intelligence model that measures volumes of prostate substructures including a transition zone, peripheral zone, central zone, and seminal vesicle. Measurements related to prostate substructures may be used to evaluate the presence of various prostate-related diseases including benign prostatic hyperplasia and prostate cancer. Detection of changes in prostate structures may visually present structural changes across multiple MRI images so that a user can more easily perform clinical diagnosis.

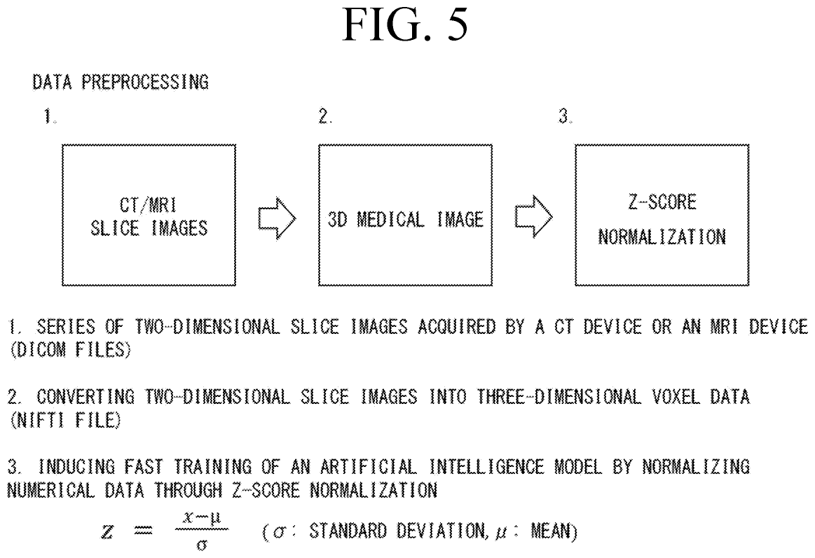

FIG. 5 illustrates an example of a preprocessing process of image data before inputting the image data to an artificial intelligence model according to various embodiments of The present disclosure.

FIG. 5 illustrates a preprocessing process of image data according to various embodiments of The present disclosure.

In a first step, a plurality of two-dimensional slice images including a prostate region of a patient are acquired using an MRI device. Multiple MRI images are captured, and each image is generally converted into and stored as a single DICOM file. These images are typically stored in a DICOM (Digital Imaging and Communications in Medicine) format and collectively form a series of image data composed of multiple slice images.

In a second step, the two-dimensional slice image data are converted into three-dimensional medical image data. The segmented DICOM files are combined into a single dataset to form three-dimensional voxel data, which are then converted into a NIFTI file format. In this process, the concept of voxel data is used. A voxel represents a three-dimensional extension of a pixel unit and constitutes volumetric data. The converted data are stored in a NIFTI (NIfTI-1) file format, which can be efficiently utilized in various medical image analysis software systems.

In a third step, numerical data are refined through Z-score normalization. Before the converted NIFTI file is input to the artificial intelligence model, Z-score normalization is applied so that the numerical data follow a normalized distribution. In medical image data, pixel values may vary depending on imaging devices or acquisition environments, which may make accurate learning by an artificial intelligence model difficult. Z-score normalization addresses such imbalance in the data and normalizes all pixel values within a consistent statistical distribution. The normalized data facilitate more efficient and faster training of the artificial intelligence model.

The Z-score normalization process is performed as follows. For each pixel value x, the mean value μ of the dataset is subtracted and the result is divided by the standard deviation σ. Through this process, the data are transformed into a distribution having a mean of 0 and a standard deviation of 1. This process may be expressed by the following equation:

Z=(x−μ)/σ.

The normalized data obtained through this process are adjusted to a consistent range across different medical images, thereby enabling the artificial intelligence model to learn the data more effectively.

Through Z-score normalization, noise in the numerical data may be reduced and the data may be refined into a normal distribution form. In particular, imbalance in pixel values in medical images may be alleviated, thereby improving data quality and significantly enhancing the training speed and accuracy of the artificial intelligence model. Accordingly, the underlying data required for detecting prostate substructures may be optimized.

The normalized data obtained through the preprocessing process are subsequently input to the artificial intelligence model. The model detects prostate substructures based on the normalized data. This preprocessing procedure serves as a critical step for improving reliability of prostate cancer diagnosis by ensuring accuracy and consistency of the input data.

Because three-dimensional medical images require a large amount of computation, inference time of the artificial intelligence model may increase significantly. Therefore, the location of the prostate is first estimated from the entire MRI image set, and only the region including the prostate is cropped and used as input to the artificial intelligence model.

For example, when a full-body MRI dataset consists of approximately 200 images each having a resolution of 512×512 pixels, only about 20 to 30 slices typically include the prostate region. In such a case, a subset of slices centered on the prostate region may be selected by including a margin of approximately 10 slices before and after the prostate region, that is, about −10 to +10 slices. The selected slices are then converted into a three-dimensional NIFTI file.

The prostate region may be identified by slicing the entire three-dimensional image dataset in frontal and lateral directions and applying a two-dimensional object detection model to accurately locate the prostate. By extracting only the relevant region through this approach, computational time may be reduced and performance of the artificial intelligence model may be optimized.

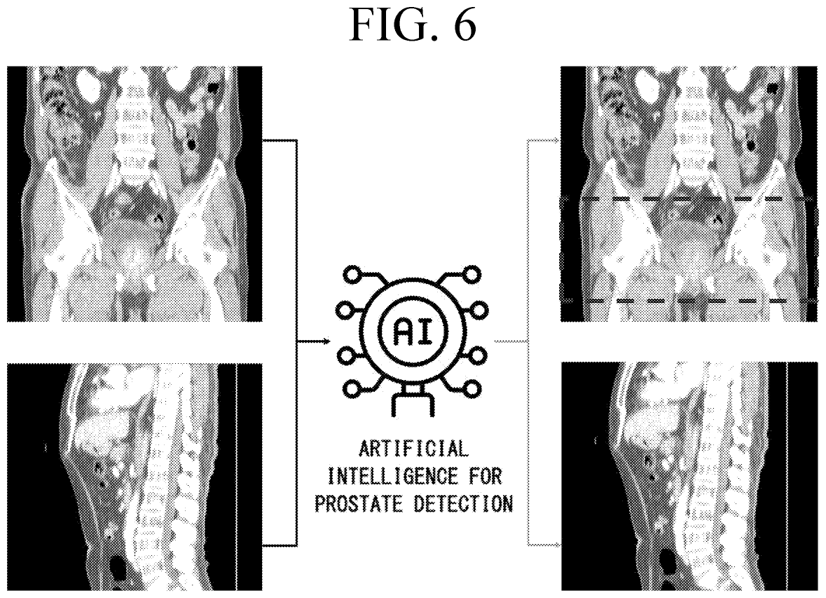

FIG. 6 illustrates an example of an artificial intelligence model for detecting prostate cancer according to various embodiments of The present disclosure.

FIG. 6 illustrates an example process in which an artificial intelligence model for prostate substructure detection analyzes MRI image data to detect prostate substructures according to various embodiments of The present disclosure. The artificial intelligence model performs a function of precisely detecting a prostate region from input medical image data and visually distinguishing prostate substructures so that the detected structures may be displayed to a user.

The artificial intelligence model of The present disclosure receives, as input, a plurality of slice images acquired by an MRI device. The anterior-posterior and lateral MRI images shown on the left side correspond to original input data. The data are composed of two-dimensional slice images, and the prostate region is detected based on these images.

The artificial intelligence model applies a prostate detection algorithm to detect the position and shape of the prostate in the input image data. The artificial intelligence (AI) model shown in the center utilizes a deep learning-based model, for example a convolutional neural network (CNN), that has been trained to learn characteristics of the prostate region. Using this model, the prostate region may be automatically segmented and a region suspected of containing cancer may be identified.

As illustrated in the upper-right image of FIG. 6, after detecting the prostate region, the artificial intelligence model identifies regions suspected of containing cancer. In the illustrated example, portions highlighted in green represent cancer-suspected regions detected by the AI model. These regions may be distinguished from surrounding normal tissue using techniques such as texture analysis or pixel-value comparison.

In addition, the dashed box shown in FIG. 6 emphasizes a Region of Interest (ROI) in which the detected prostate substructures are located.

The lower-right image of FIG. 6 illustrates an example in which the prostate region and the cancer-suspected region are visualized from a different viewing angle. The artificial intelligence model converts the detected results into two-dimensional and three-dimensional visualization data and provides the visualization data to the user so that a clinician can intuitively confirm the cancer-suspected regions.

The artificial intelligence model of The present disclosure may automatically analyze a large number of MRI slice images and rapidly and accurately detect respective prostate substructures. Through this process, the time required for diagnosis by medical personnel may be reduced and diagnostic accuracy may be improved. In addition, redundant examinations may be reduced, thereby lowering medical costs for both patients and healthcare institutions. In particular, the visualized results may serve as an important auxiliary tool in the diagnosis of prostate-related diseases.

### ARTIFICIAL INTELLIGENCE SEGMENTATION PROCESSING

The artificial intelligence model of The present disclosure includes a prostate substructure detection model.

The artificial intelligence model detects prostate substructures including at least one of a Transition Zone (TZ), a Peripheral Zone (PZ), a Central Zone (CZ), and a Seminal Vesicle (SV), and accurately calculates a volume of each detected structure.

Conventional artificial intelligence models generally applied a two-dimensional segmentation method in which sliced medical images were processed individually, and a prostate object region was masked on a slice-by-slice basis.

However, although the prostate region exhibits a relatively consistent pattern when represented as a three-dimensional structure, the prostate may appear irregular and discontinuous in individual two-dimensional slice images. As a result, it has been difficult for conventional artificial intelligence models to learn prostate structures accurately from two-dimensional slices alone.

In The present disclosure, MRI images are first converted into a three-dimensional representation, and a three-dimensional Convolutional Neural Network (3D CNN) is applied to accurately mask each prostate substructure. Through this approach, prostate substructures may be detected with improved precision.

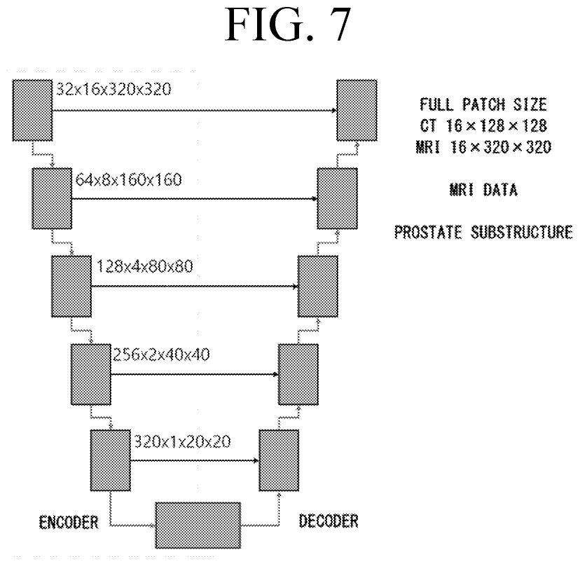

FIG. 7 illustrates an example of a 3D U-Net structure (MRI image input example) according to various embodiments of The present disclosure.

FIG. 7 illustrates an example of MRI image input utilizing a three-dimensional U-Net structure according to various embodiments of The present disclosure. The artificial intelligence model used in The present disclosure is configured as a model for detecting prostate substructures.

For prostate substructures, volumes of a Transition Zone (TZ), a Peripheral Zone (PZ), a Central Zone (CZ), and a Seminal Vesicle (SV) are calculated independently. Conventional two-dimensional segmentation models process medical images on a slice-by-slice basis. Because the prostate often appears irregular and discontinuous in individual two-dimensional slices, such approaches may result in reduced learning efficiency. In contrast, when the prostate region is represented as three-dimensional data, the structure exhibits a more consistent spatial pattern, enabling the artificial intelligence model to learn the anatomical structure more accurately.

Accordingly, segmentation processing using a three-dimensional U-Net architecture may be performed. In The present disclosure, MRI image data are first converted into a three-dimensional representation, and a three-dimensional Convolutional Neural Network (3D CNN) is applied to mask each prostate substructure. Through this approach, the location and shape of each prostate substructure may be detected with improved accuracy.

The application sequence of the artificial intelligence model is as follows.

In a first step, preprocessing of MRI images is performed, and the entire image dataset having a size of approximately 512×512×(number of slices) is prepared as input to the three-dimensional U-Net model.

In a second step, the image data are divided into patches and input to the model. In one example, an MRI image patch size may be 16×320×320.

In a third step, operations related to an encoder and a decoder of the three-dimensional U-Net are performed. The encoder extracts feature points from the input image data, while the decoder converts the extracted features into masked images corresponding to respective prostate substructure regions. In the U-Net architecture, the encoder progressively reduces the resolution of the image while extracting hierarchical features, and the decoder reconstructs the features back to the original resolution.

In a fourth step, a mask image is generated. The mask image has the same resolution as the input image, for example 512×512×(number of slices). The mask image may be represented as a binary image composed of values 0 and 1, where pixels having a value of “1” represent the corresponding prostate substructure.

In a fifth step, volumes of the respective prostate substructures are calculated. Pixel information of the generated mask image is converted into volumetric units such as cubic centimeters (cc), and the volume of each prostate substructure is calculated. In this process, pixel spacing information contained in DICOM or NIFTI files is used to compute the actual physical volume.

Finally, each detected prostate substructure is output from the program in a visualized form. Through this visualization, a user may intuitively identify each prostate substructure and perform diagnosis of prostate-related diseases more accurately and efficiently.

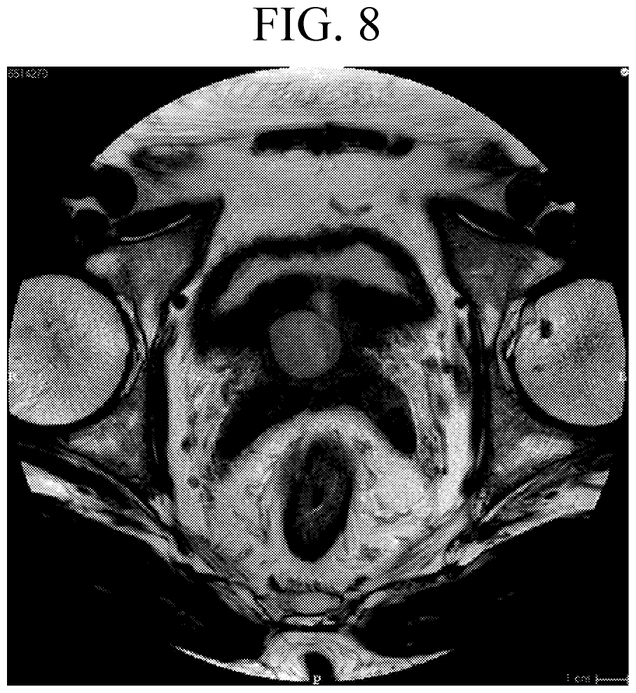

FIG. 8 illustrates an example of an output screen of an electronic device for providing prostate substructure information based on an artificial intelligence model according to various embodiments of The present disclosure.

FIG. 8 illustrates an output screen of an electronic device for providing prostate substructure information based on an artificial intelligence model according to various embodiments of The present disclosure. The present disclosure analyzes MRI medical images to automatically detect major prostate substructures and visually represent the detected structures using color distinctions so as to assist medical personnel in diagnosis.

As illustrated in FIG. 8, substructures within the prostate are distinguished by different colors. A region displayed in green represents a Transition Zone (TZ), a region displayed in red represents a Peripheral Zone (PZ), and a region displayed in blue represents a Seminal Vesicle (SV). Through such color-based visualization, clinicians can easily identify structural differences within the prostate.

The artificial intelligence model of The present disclosure applies a multi-class segmentation technique to automatically segment each prostate substructure. The Transition Zone (TZ), illustrated in green in FIG. 8, forms the central portion of the prostate, and changes in the relative size between the TZ and the Peripheral Zone (PZ) may serve as an important indicator for diagnosing diseases such as benign prostatic hyperplasia (BPH) or prostate cancer.

The Peripheral Zone (PZ), illustrated in red, surrounds the outer portion of the prostate and corresponds to the region in which prostate cancer most frequently occurs. The Seminal Vesicle (SV), illustrated in blue, is located posterior to the prostate and is a structure associated with seminal fluid production. Changes in volume or enlargement of the seminal vesicle may also serve as an important indicator in evaluating progression of prostate-related diseases.

The artificial intelligence model of The present disclosure is designed to support quantitative analysis of prostate substructures. In particular, the model may automatically measure the volume of each detected region so that clinicians can evaluate a patient's condition more objectively. For example, by analyzing the ratio between the Transition Zone (TZ) and the Peripheral Zone (PZ), the presence of benign prostatic hyperplasia may be assessed. In addition, early diagnosis of prostate cancer may be facilitated by identifying increases or decreases in the volume of specific regions.

Furthermore, structural changes in the Seminal Vesicle (SV) may be automatically detected and utilized in evaluating progression of prostate cancer.

The output screen illustrated in FIG. 8 performs an important function of assisting diagnosis by enabling visual understanding of internal prostate structures. According to embodiments of The present disclosure, the analysis results with color-distinguished regions may be provided to clinicians through integration with medical image analysis software, thereby enabling faster and more efficient diagnosis.

Such automated analysis and visualization functions reduce the workload of clinicians and minimize subjective errors that may occur during the diagnostic process, thereby supporting more accurate and reliable medical decision-making.

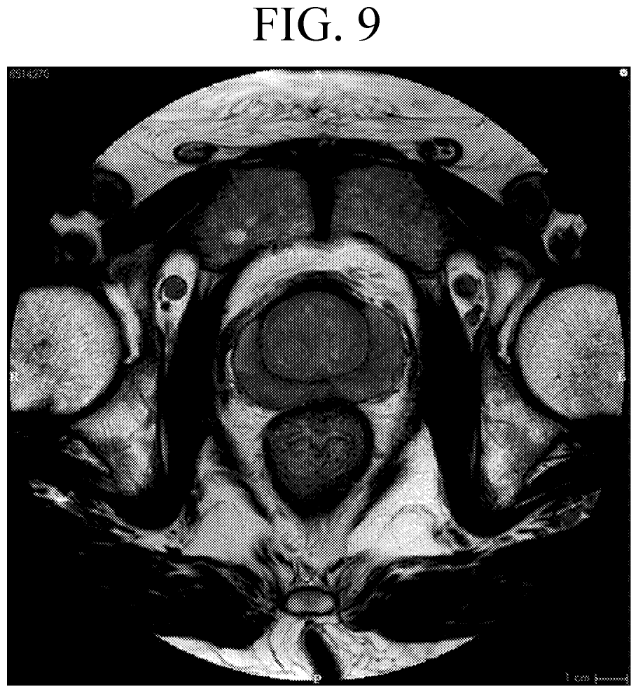

FIG. 9 illustrates an example of an output screen of an electronic device for providing prostate substructure information based on an artificial intelligence model according to various embodiments of The present disclosure.

FIG. 9 illustrates an output screen of an electronic device for providing prostate substructure information based on an artificial intelligence model according to various embodiments of The present disclosure. The present disclosure analyzes MRI medical images to automatically detect major prostate substructures and visually represent the detected structures through color distinctions in order to support clinical diagnosis.

As illustrated in FIG. 9, the Transition Zone (TZ) is distinguished in green and the Peripheral Zone (PZ) is distinguished in red. Such visual distinction assists medical personnel in clearly understanding the internal structure of the prostate.

The artificial intelligence model of The present disclosure receives medical image data as input and automatically segments major prostate regions by applying a multi-class segmentation technique. Through this process, boundaries of each prostate substructure may be clearly distinguished and quantitative volume analysis may be performed. As illustrated in FIG. 9, the Transition Zone (TZ) is located in the central region and the Peripheral Zone (PZ) surrounds the Transition Zone. Such structural distinction enables more precise diagnosis of diseases such as benign prostatic hyperplasia (BPH).

The present disclosure is designed to quantitatively measure prostate substructures and detect abnormal findings at an early stage by analyzing volume changes in specific regions. For example, enlargement of the Transition Zone (TZ) and relative volume changes of the Peripheral Zone (PZ) may serve as important indicators for evaluating the possibility of benign prostatic hyperplasia or prostate cancer. Volume values automatically calculated by the artificial intelligence model enable medical personnel to analyze the condition of a patient more objectively and may be used to determine disease progression by comparison with previous examination results.

The output screen illustrated in FIG. 9 performs an important function of assisting diagnosis by facilitating visual understanding of internal prostate structures. According to embodiments of The present disclosure, such visual analysis results may be integrated with medical image analysis software to enable medical personnel to make decisions more quickly and efficiently. Furthermore, The present disclosure improves the reliability of prostate disease diagnosis through automatic detection and visualization of prostate substructures and reduces the workload of medical personnel, thereby enabling more accurate and consistent diagnosis.

### 1. Background of the Invention

Accurate analysis of prostate substructures plays an important role in diagnosing prostate diseases and establishing treatment plans. In particular, volume analysis of prostate substructures is a critical factor in distinguishing benign prostatic hyperplasia from prostate cancer.

### 2. Object of the Invention

An objective of The present disclosure is to automatically identify prostate substructures from MRI images and accurately measure the volume of each structure.

### 3. Implementation Method

The present disclosure may be implemented through the following processes.
(1) Multi-class segmentation: Automatically distinguishing prostate substructures.
(2) Precise volume measurement: Measuring independent volumes of each prostate substructure.
(3) 3D modeling and visualization: Generating color-coded three-dimensional models of prostate substructures.
(4) Analysis and diagnostic support: Evaluating disease types and progression levels based on structural characteristics of the prostate.

### 4. Implementation Results

### SEGMENTATION RESULTS OF PROSTATE SUBSTRUCTURES FROM PROSTATE MRI

The present technology applies an image processing algorithm that automatically segments major prostate structures, including the Transition Zone (TZ), Peripheral Zone (PZ), and Seminal Vesicle (SV). A deep learning based artificial intelligence model analyzes high resolution MRI data and accurately distinguishes each prostate substructure.

The segmentation results display clear boundaries of each structure on MRI images, enabling medical professionals to evaluate prostate health conditions more precisely. The results are visualized using color codes so that structures such as TZ and PZ may be clearly identified. Such visualization greatly assists medical personnel in accurately understanding structural changes and lesion locations during diagnosis and treatment decision making.

Through application of The present disclosure, analysis of prostate substructures is transformed from a time consuming process that relies on subjective interpretation into an objective and repeatable data driven approach. This approach effectively supports early detection and management of prostate diseases and improves the consistency and accuracy of clinical outcomes.

These technical achievements represent significant progress not only for prostate cancer but also for diagnosis and treatment of other prostate related diseases, enabling medical personnel to perform patient health management with greater precision.

### SUMMARY OF THE INVENTION

The present disclosure relates to a method and an apparatus for automatically identifying prostate substructures, including a Transition Zone (TZ), a Peripheral Zone (PZ), and a Central Zone (CZ), from prostate MRI images using artificial intelligence and precisely measuring the volume of each region. Conventional manual segmentation of prostate substructures often produces variability depending on the examiner's experience and involves complex analysis procedures. The present disclosure applies artificial intelligence to automatically perform segmentation and provide quantitative information, thereby enabling more precise diagnosis and treatment planning.

### MAIN PROCESSES OF THE INVENTION

### 1. Substructure Segmentation System

(1) A multi-class segmentation model automatically distinguishes internal structures of the prostate.
(2) The Transition Zone (TZ), Peripheral Zone (PZ), and Central Zone (CZ) are independently detected and boundaries between structures are precisely identified.

### 2. Precise Measurement and Analysis

(1) Independent volumes of each structure are automatically measured.
(2) A TZ to PZ ratio is automatically calculated to support diagnosis of benign prostatic hyperplasia (BPH).

### 3. 3D Modeling and Visualization

(1) A color distinguished three dimensional model of prostate substructures is generated.
(2) Interactive functionality is provided to analyze structural size changes across cross sectional images.

### 4. Analysis and Diagnostic Support

(1) Comparative analysis of volumes of each structure relative to normal ranges is performed.
(2) An artificial intelligence based evaluation system is provided to assess the likelihood of benign prostatic hyperplasia and detect abnormal signs.

Through The present disclosure, structural changes in the prostate may be evaluated with greater precision, and objective and reliable data may be provided for diagnosis and treatment planning.

In a case where the embodiments of The present disclosure are implemented using hardware, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), or the like, configured to perform The present disclosure, may be provided in the processor of The present disclosure.

Meanwhile, the above-described method can be written as a program executable on a computer, and can be implemented in a general-purpose digital computer that operates the program using a computer-readable medium. In addition, the structure of data used in the above-described method may be recorded on a computer-readable storage medium through various means. Program storage devices usable to describe a storage device including executable computer code to perform the various methods of The present disclosure should not be understood as including transitory subjects such as carrier waves or signals. The computer-readable storage medium includes storage media such as magnetic storage media (e.g., ROM, floppy disk, hard disk, etc.) and optical reading media (e.g., CD-ROM, DVD, etc.).

The embodiments described above are combinations of elements and features of The present disclosure in a predetermined form. Each element or feature should be considered optional unless explicitly stated otherwise. Each element or feature may be implemented in a form not combined with other elements or features. Also, it is possible to configure an embodiment of The present disclosure by combining some elements and/or features. The order of operations described in the embodiments of The present disclosure may be changed. Some configurations or features of one embodiment may be included in other embodiments, or may be replaced with corresponding configurations or features of other embodiments. It is apparent that claims that do not have an explicit citation relationship in the claims may be combined to configure an embodiment or may be included as a new claim by amendment after filing.

It will be apparent to those skilled in the art that The present disclosure may be embodied in other specific forms without departing from the technical spirit and essential characteristics of The present disclosure. Therefore, the above embodiments should be considered in all respects as illustrative and not restrictive. The scope of The present disclosure should be determined by reasonable interpretation of the appended claims and all possible changes within the equivalent scope of The present disclosure.

What is claimed is:

1. A method performed by an electronic device,
wherein the electronic device comprises an input device, an output device, a processor, and a memory, the method comprising:
acquiring, by the input device, two-dimensional medical image data related to a prostate of a patient from a Magnetic Resonance Imaging (MRI) device or a Computed Tomography (CT) device;
generating, by the processor, three-dimensional voxel data of the prostate based on the two-dimensional medical image data;
applying, by the processor, a trained segmentation model stored in the memory to the three-dimensional voxel data to generate candidate label data in which each voxel is initially classified into a prostate substructure including at least one of a Peripheral Zone (PZ), a non-PZ region surrounded by or adjacent to the PZ, and a Seminal Vesicle (SV);
applying, by the processor, topological constraint rules defined based on anatomical priors of the prostate to the candidate label data to detect anatomically impossible structures including a containment violation or a connectivity violation;
executing, by the processor, a self-correcting algorithm to forcibly resolve the detected anatomically impossible structures to reconstruct the candidate label data and generate topologically corrected label data; and
outputting, by the output device, prostate substructure information including the topologically corrected label data.

2. The method of claim 1,
wherein the non-PZ region is configured to exist at a position included within a three-dimensional region represented by voxels corresponding to a Peripheral Zone (PZ) of the prostate or at a position spatially adjacent to a boundary of the three-dimensional region, the spatially adjacent position being defined as a position forming a contact relationship with at least one voxel or voxel group corresponding to the PZ in a three-dimensional space,
wherein the topological constraint rules include, based on anatomical priors of the prostate, a containment relationship requiring the non-PZ region to exist within the PZ or in a boundary-adjacent region thereof, and a connectedness constraint requiring voxels assigned to at least one of the PZ, the non-PZ region, or a Seminal Vesicle (SV) to form a single connected component,
wherein the containment violation includes a case in which at least one connected component assigned to the non-PZ region in the candidate label data exists outside the interior or the boundary-adjacent region of the PZ, the containment violation including a case in which voxels assigned to the non-PZ region are exposed outside without being surrounded by the PZ or exist at a spatially separated location from the PZ,
wherein the connectivity violation includes a case in which voxels assigned to an identical label in the candidate label data exist as a plurality of separated connected components or at least some voxels assigned to the identical label exist in the form of an isolated island, the isolated island comprising a connected component spatially separated from a main body of the identical label and not forming a continuous adjacency path with the main body, and
wherein the self-correcting algorithm generates topologically corrected label data satisfying the topological constraint rules by reassigning a label of a connected component corresponding to the containment violation in the candidate label data, or by reassigning or removing a label of a connected component corresponding to the isolated island so as to resolve anatomically impossible structures defined by the containment violation or the connectivity violation.

3. The method of claim 1,
wherein the topological constraint rules include a containment relationship configured such that a three-dimensional spatial position of voxels assigned to the non-PZ region is restricted to an interior of voxels assigned to the Peripheral Zone (PZ) or to a boundary-adjacent region thereof, and
wherein the containment violation includes a case in which at least one connected component assigned to the non-PZ region in the candidate label data exists outside the interior or the boundary-adjacent region of the PZ, the containment violation including a case in which voxels assigned to the non-PZ region are exposed outside without being surrounded by the PZ or exist at a spatially separated location from the PZ.

4. The method of claim 1,
wherein the topological constraint rules are configured such that voxels assigned to at least one of the Peripheral Zone (PZ), the non-PZ region, and the Seminal Vesicle (SV) in the candidate label data satisfy a connectedness constraint, respectively,
wherein the connectivity violation includes a case in which voxels assigned to an identical label exist as a plurality of separated connected components, or a case in which at least some of the voxels assigned to the identical label exist in the form of an isolated island, and
wherein the isolated island comprises a connected component that is spatially separated from a main body of the identical label and does not form a continuous adjacency path with the main body.

5. The method of claim 4,
wherein the connectedness constraint further includes conditional validation logic configured to determine whether the connectivity violation corresponds to an anatomically valid separation by referencing an anatomical exception database stored in the memory, without immediately determining the connectivity violation as an error even when the connectivity violation exists,
wherein the anatomical exception database includes exception rules defining types of cases in which a plurality of connected components assigned to a specific label are anatomically allowable, the exception rules being defined in association with positional characteristics or morphological characteristics of the connected components based on patient-specific characteristic data including image acquisition conditions, image distortion information, presence of Benign Prostatic Hyperplasia (BPH), surgical history, and lesion-related clinical information, and
wherein the conditional validation logic is configured to determine whether the exception rules are satisfied by matching a spatial location of the connectivity violation, morphological characteristics of the connected components, and the patient-specific characteristic data, and to allow the plurality of connected components for the specific label only when the exception rules are satisfied.

6. The method of claim 1,
wherein the self-correcting algorithm is configured to perform label reconstruction using a representation in which the candidate label data is converted from individual voxel units into voxel groups in a form of super-voxels aggregated based on label similarity and spatial adjacency,
wherein the voxel groups are defined as atomic processing units configured such that segmentation is maintained near boundaries of prostate substructures while merging is performed in internal regions so as to preserve boundary surfaces of the prostate substructures, and
wherein the label reconstruction is performed on the basis of the voxel group units so as to reduce computational complexity compared with voxel-level reconstruction while suppressing distortion of anatomical boundaries.

7. The method of claim 6,
wherein the self-correcting algorithm is configured to perform the label reconstruction using a topological graph model in which the voxel groups are treated as nodes and edges are assigned between voxel groups that are adjacent to or in contact with each other in a three-dimensional space,
wherein each of the edges includes label compatibility information indicating whether a label combination of two adjacent voxel groups is anatomically coexistent, and
wherein the label compatibility information is configured to assign different constraint strengths to at least one label pair among (1) Peripheral Zone (PZ) and non-PZ, (2) Peripheral Zone (PZ) and Seminal Vesicle (SV), and (3) non-PZ and Seminal Vesicle (SV).

8. The method of claim 7,
wherein the self-correcting algorithm is configured to perform the label reconstruction using an energy minimization technique based on Graph Cut or Markov Random Field (MRF),
wherein the energy minimization minimizes an objective function including (i) a unary cost reflecting label confidence produced by the trained segmentation model, and (ii) a pairwise cost assigning different penalties to adjacent label pairs that violate the topological constraint rules according to violation types, and
wherein the objective function is configured such that a label reconstruction that leaves a containment violation or a connectivity violation remaining is not selected by assigning a penalty structure corresponding to the violation types.

9. The method of claim 1,
wherein the topologically corrected label data simultaneously satisfies conditions in which:
(a) each connected component assigned to the non-PZ region is corrected to exist within an interior of the Peripheral Zone (PZ) or within a boundary-adjacent region thereof;
(b) voxels assigned to the non-PZ region are corrected such that no isolated island remains within the PZ; and
(c) voxels assigned to the Seminal Vesicle (SV) are corrected such that they do not overlap with voxels assigned to the PZ or the non-PZ region.

10. An electronic device comprising:
an input device; an output device; a processor; and a memory storing instructions executable by the processor,
wherein the instructions cause the processor to perform operations comprising:
acquiring, by the input device, two-dimensional medical image data related to a prostate of a patient from a Magnetic Resonance Imaging (MRI) device or a Computed Tomography (CT) device;
generating, by the processor, three-dimensional voxel data of the prostate based on the two-dimensional medical image data;
applying, by the processor, a trained segmentation model stored in the memory to the three-dimensional voxel data to generate candidate label data in which each voxel is initially classified into a prostate substructure including at least one of a Peripheral Zone (PZ), a non-PZ region surrounded by or adjacent to the PZ, and a Seminal Vesicle (SV);
applying, by the processor, topological constraint rules defined based on anatomical priors of the prostate to the candidate label data to detect anatomically impossible structures including a containment violation or a connectivity violation;
executing, by the processor, a self-correcting algorithm to forcibly resolve the detected anatomically impossible structures to reconstruct the candidate label data and generate topologically corrected label data; and
outputting, by the output device, prostate substructure information including the topologically corrected label data.
